(19) United States
(12) Patent Application Publication
(10) Pub. No.: US 2007/0174153 A1
(43) Pub. Date: Jul. 26, 2007

(54) Realignment free data report method and apparatus

(76) Inventor: Torsten Bachmann, St. Leon-Rot (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,702

(22) Filed: Dec. 30, 2005

(51) Int. Cl. G07F 19/00

(52) U.S. Cl. 705/30

(57) ABSTRACT

A system includes a source of revenue information, a source of cost information, a sales order business object that provides revenue information and attributes regarding at least one product sold, and additional business objects that provide additional attributes related to the at least one product sold. The system also includes an information joining module that joins cost information, revenue information, product attributes and other attributes to determine a profit margin associated with the product sold. In operation, replicated information related to the sale of a product and cost associated with the product is joined with replicated information with attributes from a plurality of business objects.

### BACKGROUND

In a business computing environment, reports are needed to assist those making decisions that affect the business. Reports from an accounting and finance component of a business are often relied on as a basis for tracking various aspects of a business, including the success of various components of the business. In the past, the data needed to generate various reports or accounting statements was held in a separate data base for each portion of an accounting and finance component of a business that needed the data. In many instances, the same data was stored multiple times. This wastes storage resources since the data is held redundantly. In addition, this adds to the complexity of generating reports and assuring the accuracy of a report since many times the data held by a particular accounting and financing component had to be realigned or updated with current data from another source or another data base. One example of realignment includes conversions that must be made in a data base resulting from when a customer is reassigned to another customer group. There are, of course, many other events that require realignment and conversion of a data base. Of course, the more changes, the more complex the realignment of data in the data base. If a business has multiple data bases that hold similar data, all of the independent data bases must also be converted to assure accuracy of the reports generated. This not only wastes additional computing resources but also wastes time when generating a report. Generally, most executives desire accurate and quick reports.

Many of the reports are ultimately based on transactions conducted by the business. In complex business management systems, transactions may be handled by many different parts of the system. Operations components of systems may be responsible for receiving orders, shipping, checking invoices, tracking payments and providing information to an accounting system. In some systems, the accounting function may be separate from the operations components. Such systems can be very complex, and it is difficult to track business transactions that may flow through the system, much less update or realign many separate data bases for the accounting and finance component of the business. Thus, confirming that the data is correct may be difficult and time consuming. Finding the correct data may also be difficult and time consuming.

### BRIEF DESCRIPTION OF THE DRAWINGS

FIG. 1 is a block diagram of an overall computing environment, according to an example embodiment.

FIG. 2 is a block diagram illustration of a value chain with prima nota and single point inventory objects, according to an example embodiment.

FIG. 3 is a schematic diagram of a data base which is controlled by one or more business objects and business components, and which is used by multiple portions of the accounting and finance component, according to an example embodiment (in red).

FIG. 4 is a block diagram showing the interrelationship between a business intelligence layer, an application program layer, and a financial accounting component, according to an example embodiment.

FIG. 5 is a table formed in cache memory location after merging data from various infocubes, according to an example embodiment.

FIG. 6 is a flow diagram of a method for replicating accounting information, and other information and generating a report, according to an example embodiment.

FIG. 7 is a flow diagram of a method for and generating a report, according to an example embodiment.

FIG. 8 is a schematic of a computer system that executes programming, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

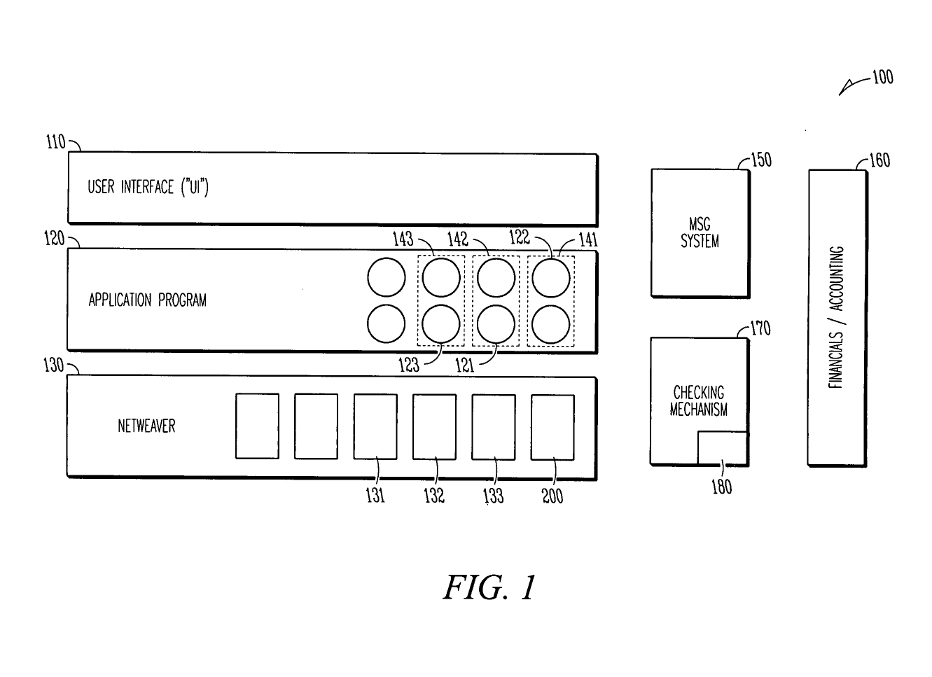

FIG. 1 is a block diagram of a computing system 100, according to an example embodiment. The computing environment 100 includes a user interface 110, an application program level 120 and a comprehensive integration and application platform layer 130. The comprehensive integration and application platform layer works with an existing infrastructure to enable and manage change. The comprehensive integration and application platform 130 includes a plurality of business applications, known as business components, which reduce the need for custom integration. The comprehensive integration and application platform includes a business component 131, 132, and 133. The comprehensive integration and application platform 130 also includes a business component 200 which includes various integration tools for performing business analysis on business information within the computing environment 100. The business component 200 is sometimes referred to as a business intelligence layer. In some embodiments, the business intelligence layer is an application platform component. The application program layer 120 also includes a number of distributed objects 121, 122, 123. The object is a technical representation of a concept that includes data and logic. In one example embodiment, the object, such as object 121, 122, 123, is referred to as a business object and is a technical representation of a business concept that includes data and logic. As shown, the business objects 121, 122, 123 can be grouped into logical deployment units, such as logical deployment units 141, 142, 143. A logical deployment unit is a grouping of business objects that perform tasks related to a function. As shown, the system also includes a messaging system 150 that passes messages from the logical deployment units 141, 142, 143 to a financial accounting component 160. When a message comes from a logical deployment unit it may actually be coming from a business object within the logical deployment unit. For example, a message from the logical deployment unit 141 may actually be coming from the business object 122 within the logical deployment unit 141. In one example embodiment, the logical deployment units 141, 142, 143 correspond to groupings of business objects that handle operational transactions such as orders, delivery, invoicing, due management, and payment. The logical deployment units 141, 142, 143 are separate from the financial accounting component 160 and the messages, in one example embodiment, are sent from the logical deployment units 141, 142, 143 to the financial accounting component as the transactions occur. The financials accounting component receives the messages from the various logical deployment units 141, 142, 143 and derives the accounting documents from this messages. For example, messages are sent from a sales order or invoice business object in a logical deployment unit and entered received from the financial accounting system.

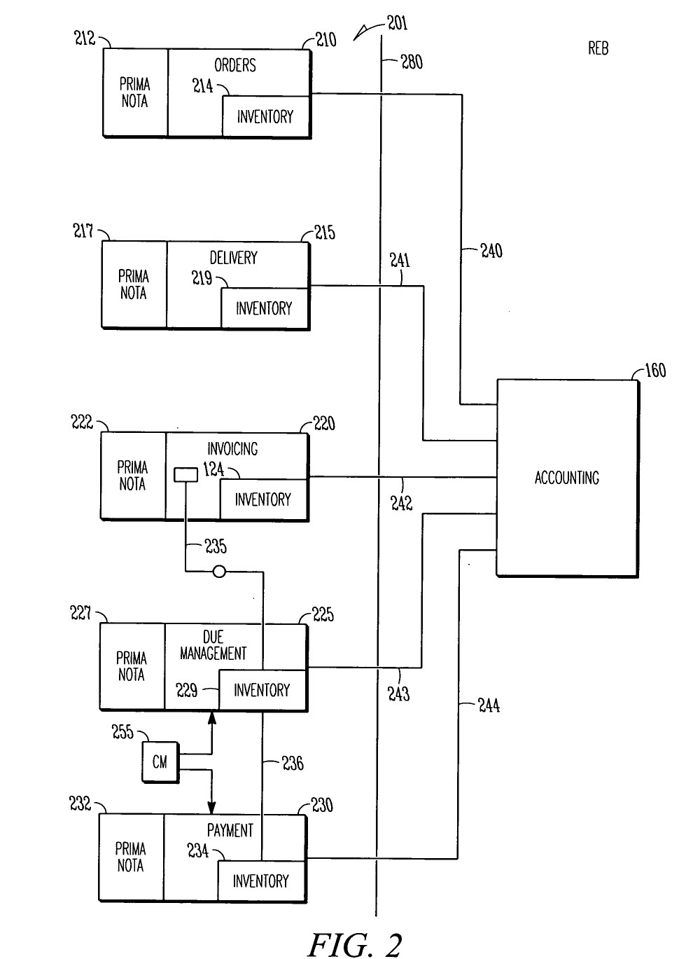

FIG. 2 is a block diagram illustration of a value chain 201 that includes a number of logical deployment units that include business objects, according to an example embodiment. The value chain 201 is a portion of the computing environment 100 that includes logical deployment units that produce transaction records that are sent to the financial accounting component 160 by way of the messaging system 150. Of course, the accounting and finance component 160 can also receive messages from other logical deployment units outside the value chain 201. Selected logical deployment units in the value chain 201 include an orders logical deployment unit, 210, a delivery logical deployment unit 215, an invoicing logical deployment unit 220, a due management logical deployment unit 225 and a payment logical deployment unit 230. Orders logical deployment unit 210 may include prima nota 212 and an order inventory object 214. The prima nota 212 consists of images of original business documents, such as actual customer orders and contracts in one embodiment. These are the original business documents, and in one embodiment, are assigned a unique internal identification or representation such as a string of numbers and/or characters, to ensure proper referencing. While such prima nota 212 are the primary business documents, copies of them may be provided if desired.

Order inventory object 214 may include an inventory of all current unshipped orders in one embodiment. It is updated by the use of messages generated as a result of transactions. A transaction may be performed by the orders logical deployment unit 210 in response to receipt of an order. A message to update the inventory object 214 may also result from a delivery transaction via delivery logical deployment unit 215.

Delivery logical deployment unit 215 may also include prima nota 217 that contains primary business documents, such as delivery documents, and a delivery inventory 219, which again may be updated via messages generated by transactions from one or more logical deployment units.

Invoicing logical deployment unit 220 may also include prima nota 222 that contains primary copies of invoices and other business documents related to functions that the invoicing logical deployment unit 220 performs. Invoicing logical deployment unit 220 may also contain an inventory object 224 that contains a single point of inventory for invoices. The transactions may result in increases and reductions in the inventory of inventory object 224.

Due management logical deployment unit 225 may also include prima nota 227, such as documents related to amounts due from business partners, collections notices, etc. Due management logical deployment unit 225 may also include a due inventory object that represents amounts due from business partners. It may be updated via messages resulting from transactions in various logical deployment units, such as invoicing via the invoicing logical deployment unit as represented by line 235. It may also be updated by messages generated from payments received via payment logical deployment unit 230.

Payment logical deployment unit 230 may also include prima nota 232, such as documents related to payments. Payments may take many different forms, such as cash, check, money order, credit card, offsets, and electronic funds transfer. The prima nota may be scanned copies of checks, or associated communications with such payments. The payments are transactions that are processed by the payment logical deployment unit 230 and result in messages incrementing and decrementing a payment register inventory object 234.

In one embodiment, the logical deployment units perform transactions that modify one or more inventory objects, and also may result in communications of such transactions in the form of messages as indicated at 240, 241, 242, 243 and 244 being sent to a separate accounting and finance system 160. The business operations or value chain 201 and the logical deployment units within the value chain 201 is a separate system from the accounting and finance system 160 as depicted by a line 280 in FIG. 2. These separate systems communicate back and forth via messages. In one embodiment, the business operations system 201 is a cash based system, where cash is calculated in real time. The accounting system may operate on an accrual basis. By using messages between these two different systems, and keeping business documents and inventory separate in the operations system, each system is free to select how to handle transactions.

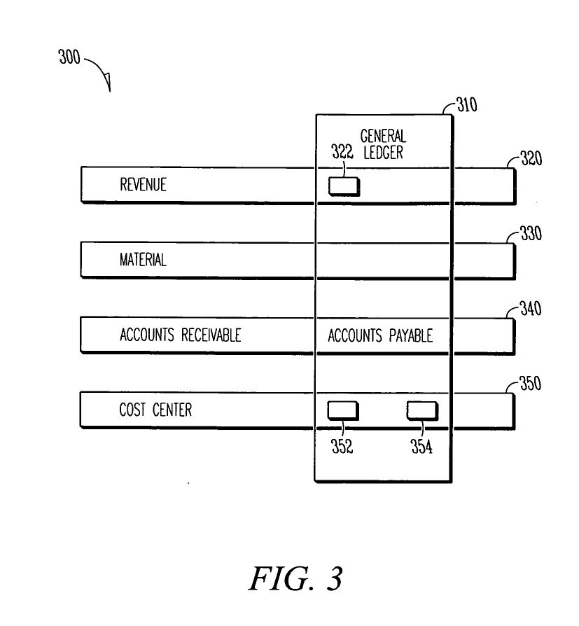

FIG. 3 is a schematic diagram of a portion of a data base 300 which is controlled by one or more business objects and business components, and which is used by multiple portions of the accounting and finance component 160, according to an example embodiment. The portion of the data base 300 includes the general ledger 310. The general ledger 310 is used to record transactions that relate to revenue and sales as depicted by reference numeral 320, materials as depicted by reference number 330, accounts receivable and accounts payable as depicted by reference numeral 340 as well as cost centers as depicted by reference numeral 350. The general ledger 310 is basically a master ledger. Subledgers are formed and the information from them is placed into the general ledger. For example, the revenue portion includes a sales ledger 322. The cost center 350 includes information from subledgers such as an overhead cost ledger 352 and a direct cost ledger 354. Thus, the subledgers 322,352, 354 can be extracted from the general ledger 310. With such an arrangement the general ledger 310 is the only thing that needs to be current since the subledgers 322, 352, 354 come from the general ledger 310. Provided that the general ledger 310 is current or contains current records related to transactions all subledgers derived from it are current. The portion of the data base 300 includes a sales ledger.

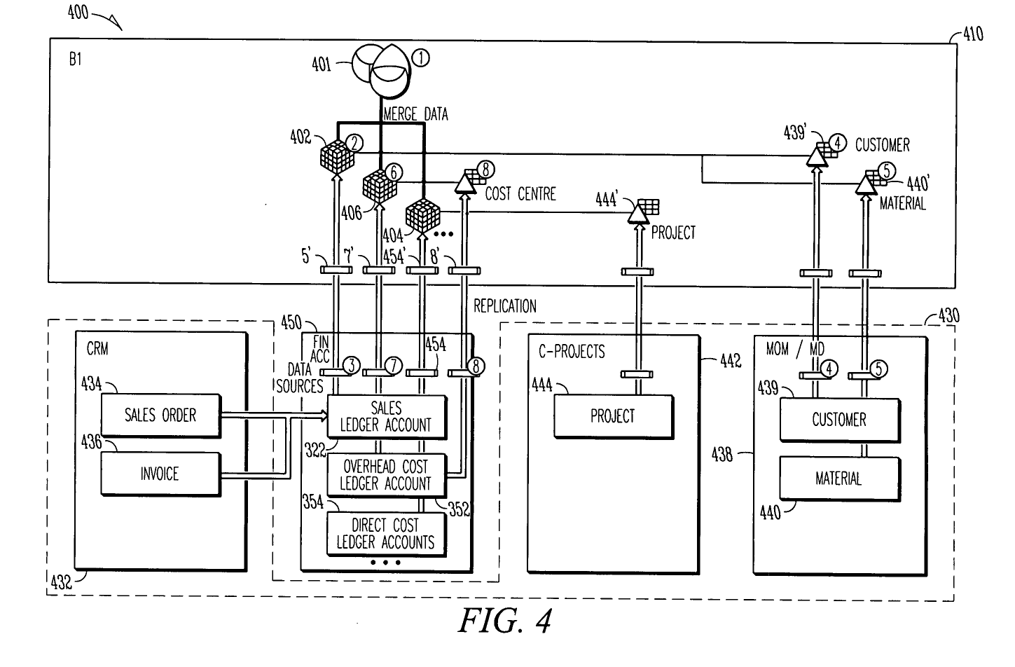

FIG. 4 is a block diagram 400 showing the interrelationship between a business intelligence layer 410, an application program layer 430 and a financial accounting component 450, according to an example embodiment. The application program layer 430 includes a customer relations management logical deployment unit 432 that includes business objects such as a sales order business object 434 and an invoice business object 436. The application program layer 430 also includes a master organizational management/materials delivered logical deployment unit 438. The logical deployment unit 438 includes business objects related to the organization and structure of a customer 439, and a business object related to materials delivered 440. The application program layer 430 also includes a C-projects logical deployment unit 442 which includes a project business object 444. The diagram 400 also shows a financial accounting component 450. Within the financial accounting component 450 is the sales ledger account 322, the overhead cost ledger account 352 and the direct cost ledger account 354. The sales order business object 434 on the invoice business object 436 produce messages which are passed by the messaging system 150 (see FIG. 1) to the financial accounting component 450. Specifically, the information from the sales order business object 434 and the invoice business object 436 include transactions and other information that are used to produce a sales ledger account 322 in the financial accounting component 450. Also formed are the overhead cost ledger 352 and the direct cost ledger 354. The subledgers are produced as a result of recording or receiving messages from other business objects. For the sake of simplicity the source of the overhead cost ledger 352 and the direct cost ledger 354 are not shown in diagram 400.

The information the sales ledger account 322, the overhead cost ledger account 352, and the direct cost ledger account 354 can be used to determine profit margins or a profit margin for the business. In this particular example embodiment, the sales ledger account 322 the overhead cost ledger account 352 and the direct cost ledger account 354 are used to determine a profit margin on a product for a specific segment for a specific market segment.

The business intelligence layer 410 is used to provide analysis on data from business objects in the application program layer 430. The business intelligence layer 410 is one source of analytical information. Another source of analytical information is financial accounting data from various subledgers 322, 352, 354 in the financial accounting component 450. The financial accounting data is supplemented by the analytical information from the business intelligence layer. A report requires certain data to be analyzed by the business intelligence layer 410. The author of a report generally knows the type of data needed in the business intelligence layer 410 from the various business objects and the financial accounting component. As a consequence, the data needed to produce the business report is placed in a data source. For example, data from the sales ledger account 322 is placed in the data source 3, and data from the overhead cost ledger 352 is placed in the data source 7, and data from the direct cost ledger is placed in the data source 454. Additional data from the overhead cost ledger 352 is placed in data source 8. The data in the various data sources 3, 7, 454, 8 is replicated in the business intelligence layer 410 as depicted by references 3′, 7′, 454′, and 8′ found in the business intelligence layer 410.

An operational data store is performed on these various replicated data sources 3′, 7′, 454′, and 8′ to normalize the data placed in various infocubes. For example, replicated and normalized sales ledger account data is found in infocube 102. Replicated and normalized data from the overhead cost ledger account is found in infocube 106. Still further overhead cost ledger data is found in infocube 108. The normalized data found in infocubes 102, 106, and 104 are then merged to form a large table of data 101 that includes sales ledger account information overhead cost ledger account information and direct cost ledger account information. The infocube 108 includes overhead cost ledger account information related to a cost center. The cost center information from infocube 108 is merged with the information found in infocube 106. Similarly, replicated and normalized data from infocube 444′ which is related to a special project marketing. An example of special project marketing includes industrial fairs.

Data from the various infocubes are merged. Merging is a process of taking the replicated and normalized data are merging it with other replicated and normalized data to form a master data cube 101. The information is placed in a table which is stored in a cache memory location. The master data cube 101 may also be referred to as a cache memory location 101. The infocubes 404, 402 and 406 associated from the financial accounting component are merged. In addition to accounting information other information from business objects such as the sales order business object 434 the customer business object 439 and the materials delivered business object 440 are also merged with the accounting data. Replicated and normalized data from an infocube 444′ is input into infocube 404. Replicated and normalized data from an infocube 439′ is merged into infocube 402, and replicated and normalized data from the material infocube 440′ is also merged into infocube 402.

The result of merging accounting data and various other data including attributes from other business objects is that the resulting information merge can be used to segment the data to identify a specific market segment for a specific product. For example, product attributes such as the color of the product, the type of product, and where the product is sold is available from the customer relations management logical deployment unit 432 and specifically from the sales order business object 434 and the invoice business object 436. Further information about the customer can be retrieved from other business objects such as the customer business object 439. The material used to make the particular product can be determined from the material business object. These various attributes are then added to the infocubes which are joined to form a table in a cache memory or master infocube 101 in the business intelligence layer 410. The cache memory 101 can then be queried to produce a report.

As an example the cache memory 101 and specifically the table produced in the cache memory 101 can be queried to provide contribution profit margin reporting on specific products or for a particular product. The calculation includes:
Revenue−Discounts−Cost of goods sold=Cost margin₁.
Cost margin₁−allocated overhead=profit related to the cost margin

In short, the method includes replicating data from various portions of the financial accounting component 450 and adding to that various attributes from various business objects such as a sales order business object 434, business object 436, a customer business object 439, materials delivered business objects 440 and a project business object 444. By adding various attributes about the product, where it was sold, the channel used for the sale, where the customer is located and similar or other attributes the resulting table 500 stored in the cache memory can be queried to produce cost margin profit calculations for very specific segments of a market and for very specific products in the market. It should also be noted that the attributes discussed above can be added to further scranularize the analysis so that even a more specific cost margin profit could be determined for a certain product in a certain market.

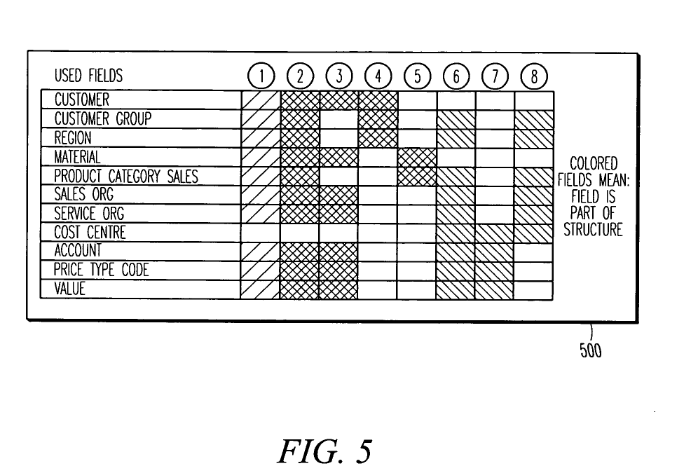

FIG. 5 is a table formed in cache memory 101 after merging data from the various infocubes 402, 406, 404, 408, 440′, 444′, and 439′. The table 500 includes various fields including a customer, customer group, region, material, product category sales, sales organization information, service organization information, cost center information, account, price type code, and value. Other attributes related to other business objects could also be added to this table. The attributes found in columns 2, 3, 4, and 5 include attributes related to revenue and the product and the customer. The attributes in column 6, 7, and 8 of table 500 are related to accounting information that is also related to a product. Column 1 shows the attributes that are found in the cache memory location 401.

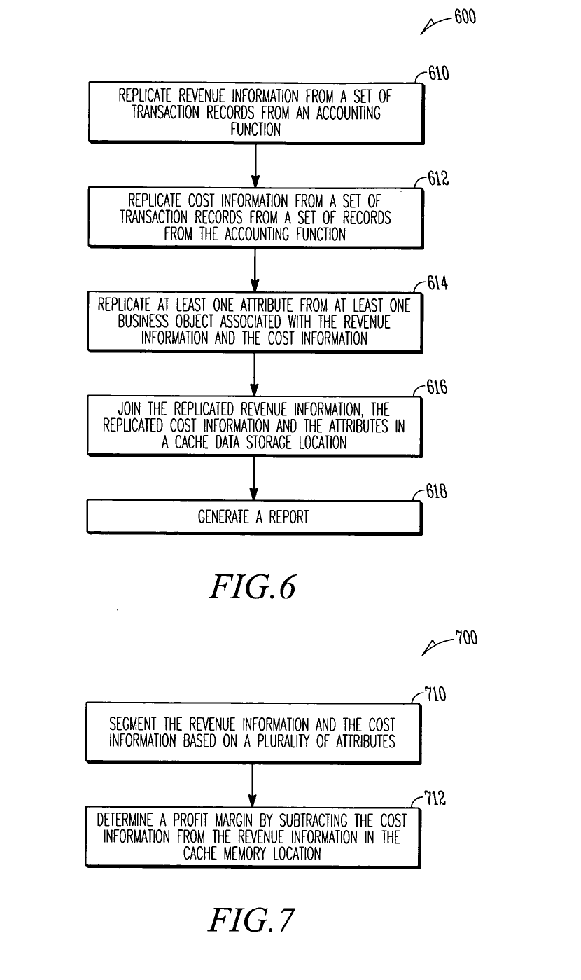

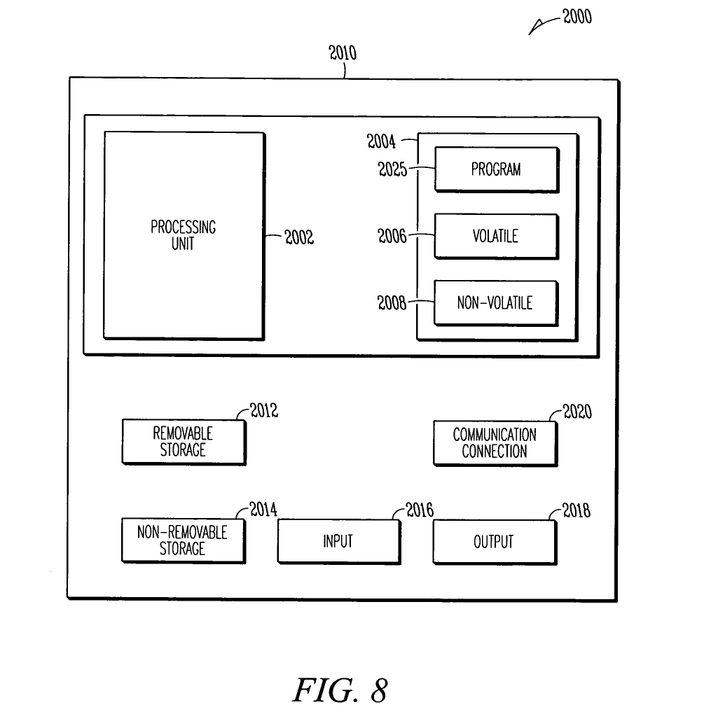

FIG. 6 is a flow diagram of a method 600 for replicating accounting information and other information and generating a report, according to an example embodiment. The method 600 includes replicating revenue information from a set of transaction records from an accounting function 610, replicating cost information from a set of transaction records from a set of records from the accounting function 612, and replicating at least one attribute from at least one business object associated with the revenue information and the cost information 614. The method 600 also includes joining the replicated revenue information, the replicated cost information and the attributes in a cache data storage location 616. The joined information in the cache data storage location is queried to generate a report 618. In some embodiments, replicating revenue information 610 includes selecting information from a sales ledger, and replicating cost information 612 includes selecting information from a cost ledger. In one example embodiment, replicating cost information 614 includes selecting information from a direct cost ledger. Replicating at least one attribute includes selecting information from a business object that includes customer data, or selecting information from a business object that includes region where a product is purchased, or selecting information from a business object that includes sales organization. In another embodiment, replicating at least one attribute 614 includes selecting a plurality of attributes, and segmenting the revenue information and the cost information based on the selected plurality of attributes. The method 600, in some embodiments, also includes determining a profit margin by subtracting the cost information from the revenue information in the cache memory location. In still other embodiments, the method 600 includes querying the cache data storage location, and generating a report. In one example embodiment, replicating revenue information 610, replicating cost information 612, replicating at least one attribute 614, and joining the replicated revenue information, the replicated cost information and the at least one attribute 616 occurs substantially simultaneously with generating the report 618. Replicating revenue information, replicating cost information, and joining the replicated revenue information, and the replicated cost information may prevent realignment of transaction records before generating the report.

FIG. 7 is a flow diagram of a method 700 for generating a report according to an example embodiment. The method 700 includes segmenting the revenue information and the cost information based on a plurality of attributes from business objects as depicted by reference numeral 710. Once the revenue information and cost information is segmented, a profit margin is determined by subtracting the cost information from the revenue information and the cache memory location, as depicted by reference numeral 712. It should be noted that the cache memory can be any type of memory. For example, the cache memory could be volatile or nonvolatile cache memory as is shown in FIG. 4 as in the business intelligence layer 410 and is depicted by reference numeral 401.

A system includes a source of revenue information, a source of cost information, a sales order business object that provides revenue information and attributes regarding at least one product sold, and additional business objects that provide additional attributes related to the at least one product sold. The system also includes an information joining module that joins cost information, revenue information, product attributes and other attributes to determine a profit margin associated with the product sold. In one example embodiment, the source of revenue information and the source of cost information is from an accounting component. The accounting component is separate from the sales order business object and the additional business objects in the system. The system also includes a messaging system for sending messages from the sales order business object to the accounting component. The system also includes a report generating module. The system, in some example embodiments, includes a cache memory location for storing the joined cost information, revenue information, product attributes and other attributes. The joined cost information, revenue information, product attributes and other attributes can be stored in a table.

A block diagram of a computer system 2000 that executes programming for performing the above algorithm is shown in FIG. 9, according to an example embodiment. A general computing device in the form of a computer 2010, may include a processing unit 2002, memory 2004, removable storage 2012, and non-removable storage 2014. Memory 2004 may include volatile memory 2006 and non-volatile memory 2008. Computer 2010 may include—or have access to a computing environment that includes—a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2002 of the computer 2010. A hard drive, CD-ROM, and RAM are some examples of articles including a computer-readable medium. For example, a computer program 2025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 2000 to provide generic access controls in a COM based computer network system having multiple users and servers.

A computer readable medium having instructions for causing a computer to perform a method including replicating information related to the sale of a product and cost associated with the product, and joining the replicated information with attributes from a plurality of business objects. The computer medium also has instructions for causing a computer to determine a profit margin related to the product, and segmenting the profit margin using the attributes from the plurality of business objects. The computer readable medium can also include instructions for implementing any or all of the other steps of the methods 600 and 700 discussed above.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method comprising:
replicating revenue information from a set of transaction records from an accounting function;
replicating cost information from a set of transaction records from a set of records from the accounting function;
replicating at least one attribute from at least one business object associated with the revenue information and the cost information; and
joining the replicated revenue information, the replicated cost information and the attributes in a cache data storage location.

2. The method of claim 1 further comprising querying the cache data storage location.

3. The method of claim 2 wherein replicating revenue information includes selecting information from a sales ledger.

4. The method of claim 2 wherein replicating cost information includes selecting information from a cost ledger.

5. The method of claim 2 wherein replicating cost information includes selecting information from a direct cost ledger.

6. The method of claim 2 wherein replicating at least one attribute includes selecting information from a business object that includes customer data.

7. The method of claim 2 wherein replicating at least one attribute includes selecting information from a business object that includes region where a product is purchased.

8. The method of claim 2 wherein replicating attributes includes selecting information from a business object that includes sales organization.

9. The method of claim 1 wherein replicating at least one attribute includes
selecting a plurality of attributes;
segmenting the revenue information and the cost information based on the selected plurality of attributes.

10. The method of claim 9 further comprising determining a profit margin by subtracting the cost information from the revenue information in the cache memory location.

11. The method of claim 3 further comprising;
querying the cache data storage location; and
generating a report, wherein replicating revenue information, replicating cost information, replicating at least one attribute, and joining the replicated revenue information, the replicated cost information and the at least one attribute occurs substantially simultaneously with generating the report.

12. The method of claim 3 further comprising;
querying the cache data storage location; and
generating a report, wherein replicating revenue information, replicating cost information, and joining the replicated revenue information, and the replicated cost information prevents realignment of transaction records before generating the report.

13. A system comprising:
a source of revenue information;
a source of cost information;
a sales order business object that provides revenue information and attributes regarding at least one product sold;
additional business objects that provide additional attributes related to the at least one product sold;
an information joining module that joins cost information, revenue information, product attributes and other attributes to determine a profit margin associated with the product sold.

14. The system of claim 13 wherein the source of revenue information and the source of cost information is from an accounting component.

15. The system of claim 14 wherein the accounting component is separate from the sales order business object and the additional business objects.

16. The system of claim 15 further comprising a messaging system for sending messages from the sales order business object to the accounting component.

17. The system of claim 13 further comprising a report generating module.

18. The system of claim 13 further comprising a cache memory location for storing the joined cost information, revenue information, product attributes and other attributes.

19. The system of claim 18 further comprising a table for storing the joined cost information, revenue information, product attributes and other attributes.

20. A computer readable medium having instructions for causing a computer to perform a method comprising:
replicating information related to the sale of a product and cost associated with the product; and
joining the replicated information with attributes from a plurality of business objects.

21. The computer readable medium of claim 20 having instructions for causing a computer to perform a method further comprising;
determining a profit margin related to the product; and
segmenting the profit margin using the attributes from the plurality of business objects.
